(19) United States
(12) Patent Application Publication
(10) Pub. No.: US 2010/0285596 A1
(43) Pub. Date: Nov. 11, 2010

(54) METHODS FOR ISOLATING FUNCTIONALIZED MACROMOLECULES

(75) Inventors: Ying Qing Yu, Uxbridge, MA (US); Martin Gilar, Franklin, MA (US)

Correspondence Address: EDWARDS ANGELL PALMER & DODGE LLP, P.O. BOX 55874, BOSTON, MA, 02205, US

(73) Assignee: WATERS TECHNOLOGIES CORPORATION, Milford, MA (US)

(21) Appl. No.: 12/676,009

(22) PCT Filed: Sep. 5, 2008
(86) PCT No.: PCT/US08/10396

§ 371 Date: Jul. 19, 2010

Related U.S. Application Data
(60) Provisional application No. 60/967,667, filed on Sep. 6, 2007.

(51) Int. Cl. G01N 33/92; G01N 33/00; C07K 1/16; C07H 21/02; C07H 21/04; C07H 21/00; C08F 6/28; B01D 15/00

(52) U.S. Cl. 436/71; 436/86; 436/94; 530/344; 530/415; 536/23.1; 536/25.41; 528/482; 422/261

(57) ABSTRACT

The invention provides methods of isolating, purifying, analyzing and/or detecting, functionalized macromolecules, e.g., peptides, phosphopeptides, polypeptides, proteins, oligonucleotides, or phospholipids in a sample, e.g., a biological mixture, using solid phase extraction with an alumina sorbent packed in a micro-elution plate.

### RELATED APPLICATION

This application claims priority to U.S. provisional patent application Ser. No. 60/967,667, filed Sep. 6, 2007, the entire contents of which are incorporated herein by reference.

### BACKGROUND OF THE INVENTION

Solid phase extraction (SPE) is a chromatographic technique often used in conjunction with quantitative chemical analysis, for example, high performance liquid chromatography (HPLC), or gas chromatography (GC). The goal of SPE is to isolate target analytes from a complex sample matrix containing unwanted contaminants. The isolated target analytes are recovered in a solution that is compatible with quantitative analysis. This final solution containing the target compound can be directly used for analysis or evaporated and reconstituted in another solution of a lesser volume for the purpose of further concentrating the target compound, making it more amenable to detection and measurement.

Solid phase extraction has been used to extract analytes from liquids to prepare them for analysis. Proteins and nucleic acid materials are frequently isolated from biological samples by passing them through a packed column and cartridge containing a solid phase where the molecules of interest are adsorbed. After the sample has passed through the column and the sample molecules have been adsorbed, a solvent is used to desorb the molecules of interest and form a concentrated solution.

It is particularly important to be able to purify and concentrate non-polynucleotide biomolecules such as polypeptides and polysaccharides, because these molecules are not amenable to the types of amplification techniques routinely used with nucleic acids. Many proteins and peptides are only expressed at extremely low levels and in the presence of a vast excess of contaminating proteins and other cellular constituents. For this reason, it is often necessary to purify and concentrate a protein sample of interest prior to performing analytical techniques such as MS, SPR, NMR, X-ray crystallography and the like. These techniques typically only require a small volume of sample, but it must be presented at a sufficiently high concentration and interfering contaminants should be removed. Hence, there is a need for sample preparation methods that permit the manipulation and processing of small sample volumes with minimal sample loss.

Other desirable attributes of a sample preparation technology are the ability to purify and manipulate protein complexes. In many applications, it is also critical that the purified protein retain its native function.

Devices designed for SPE typically include a chromatographic sorbent which allows the user to preferentially retain target components. Once a sample is loaded onto the sorbent, a series of tailored washing and elution fluids are passed through the device, to separate contaminants from target sample components, and then to collect the target sample components for further analysis.

SPE devices typically include a sample holding reservoir, a means for containing the sorbent, and a fluid conduit, or spout for directing the fluids exiting the device into suitable collection containers. The SPE device may be in a single well format, which is convenient and cost effective for preparing a small number of samples, or a multi-well format, which is well suited for preparing large numbers of samples in parallel.

Multi-well formats are commonly used with robotic fluid dispensing systems. Typical multi-well formats include 48-, 96-, and 384-well standard plate formats. Fluids are usually forced through the SPE device and into the collection containers, either by drawing a vacuum across the device with a specially designed vacuum manifold, or by using centrifugal or gravitational force. Centrifugal force is generated by placing the SPE device, together with a suitable collection tray, into a centrifuge specifically designed for the intended purpose.

Typical SPE methods contain a sequence of steps, each with a specific purpose. The first step, referred to as the “conditioning” step, prepares the device for receiving the sample. This initial rinse is generally followed with a highly aqueous solvent rinse, often containing pH buffers or other modifiers, which will prepare the chromatographic sorbent to preferentially retain the target sample components. Once conditioned, the SPE device is ready to receive the sample.

The second step, referred to as the “loading” step, involves passing the sample through the device. During loading, the sample components, along with many interferences are adsorbed onto the chromatographic sorbent. Once loading is complete, a “washing” step is used to rinse away interfering contaminants, while allowing the target compounds to remain retained on the sorbent. The washing step is then followed by an “elution” step, which typically uses a fluid containing a high percentage of an organic solvent, such as methanol or acetonitrile. The elution solvent is chosen to effectively release the target compounds from the chromatographic sorbent, and into a suitable sample container.

In many cases, SPE samples may be evaporated to dryness (“drydown”), and then reconstituted in a more aqueous mixture (“reconstitution”) before being injected into an HPLC system. It is advantageous for an SPE device to have a high capacity for retaining target compounds of a wide range of chromatographic polarities, to be capable of maintaining target compound retention as sample contaminants are washed to waste, and then to provide the capability to elute target compounds in as small an elution volume as possible, thereby maximizing the degree of target compound concentration obtained during SPE.

Traditional SPE device designs comprise the following for the sorbent material: packed bed of sorbent particles, embedding sorbent particles within a membrane, and glass fiber based extraction discs containing chromatographic particles. Other common examples include porous silica that has been surface derivatized with octydecyl (C₁₈) or octyl (C₈) functional groups. The packing material for use in the solid phase extraction also typically includes those using an inorganic substrate, such as chemical bond-type silica gel where the surface of silica gel is subjected to a chemical modification with an octadecyl group to render the surface of the packing material hydrophobic, and those using an organic substrate, such as synthetic polymer represented by styrene-divinylbenzene. Porous particles that are based on organic polymers are also widely used.

The isolation of funcitonalized compounds, in particular, peptides, polypeptides, proteins, oligonucleotides, or phospholipids presents unique challenges. Traditional SPE devices, Immobilized Metal Affinity Chromatography (IMAC) methods, and Titanium dioxide chromatography have been used to isolate or enrich such compounds. More recently, enrichment of phosphorylated proteins and peptides from complex mixtures is described using metal oxide/hydroxide affinity chromatography (MOAC). Proteomics 5: 4389-4397 (2005). However, these methods are unsuccessful in dealing with the co-adsorption of undesirable compounds along with the target compounds.

Therefore, there is a need for methods that facilitate the selective isolation, purification, detection and/or identification of functionalized compounds, i.e., peptides, phosphopeptides, polypeptides, proteins, phosphoproteins, oligonucleotides, or phospholipids from complex mixtures, particularly those obtained from biological fluids/samples.

### SUMMARY OF THE INVENTION

In one aspect, the invention provides a method for selectively isolating a functionalized macromolecule from a sample, the method comprising the steps of:

a) loading a sample containing a functionalized macromolecule onto a solid phase extraction (SPE) device comprising a packed alumina sorbent under conditions such that the functionalized macromolecule is selectively adsorbed onto the alumina sorbent; and

b) eluting the adsorbed functionalized macromolecule from the alumina sorbent, thereby selectively isolating the functionalized macromolecule from the sample.

In another aspect, the invention provides a method for selectively isolating a plurality of functionalized macromolecules from a sample, the method comprising the steps of:

a) loading a sample containing a plurality of functionalized macromolecules onto a first solid phase extraction (SPE) device comprising a packed alumina sorbent under conditions such the plurality of functionalized macromolecule are selectively adsorbed onto the alumina sorbent; and

b) eluting the adsorbed functionalized macromolecules from the alumina sorbent;

c) collect at least one fraction;

d) loading the at least one fraction onto a second solid phase extraction (SPE) device comprising a packed alumina sorbent under conditions such that at least two functionalized macromolecules are selectively adsorbed onto the alumina sorbent; and

c) eluting the at least two adsorbed functionalized macromolecules from the alumina sorbent of the second solid phase extraction (SPE) device, thereby selectively isolating a plurality of functionalized macromolecules from the sample.

In yet another aspect, the invention provides a method for purifying a functionalized macromolecule contained in a sample, the method comprising:

a) loading a sample containing a functionalized macromolecule onto a solid phase extraction (SPE) device comprising a packed alumina sorbent under conditions such that the functionalized macromolecule is selectively adsorbed onto the alumina sorbent; and

b) eluting the adsorbed functionalized macromolecule from the alumina sorbent, thereby selectively isolating the functionalized macromolecule from the sample, thereby purifying a functionalized macromolecule.

In still another aspect, the invention provides a method for detecting a functionalized macromolecule in a sample, the method comprising the steps of:

a) loading a sample containing a functionalized macromolecule onto a solid phase extraction (SPE) device comprising a packed alumina sorbent under conditions such that the functionalized macromolecule is selectively adsorbed onto the alumina sorbent; and

b) eluting the adsorbed functionalized macromolecule from the alumina sorbent, thereby selectively isolating the functionalized macromolecule from the sample, thereby purifying a functionalized macromolecule; and

c) detecting the functionalized macromolecule.

Another aspect of the invention provides a method for selectively isolating a phosphopeptide, oligonucleotide or phospholipid from a sample comprising a biological mixture, the method comprising the steps of:

a) dissolving the sample in a solution comprising an acid and an organic solvent;

b) loading the dissolved sample onto a solid phase elution plate or column comprising a packed alumina sorbent under conditions such that the phosphopeptide, oligonucleotide or phospholipid is selectively adsorbed onto the alumina sorbent;

c) eluting the phosphopeptide, oligonucleotide or phospholipid from the alumina using a basic mobile phase; and

d) collecting the isolated phosphopeptide, oligonucleotide or phospholipid, thereby selectively isolating a phosphopeptide, oligonucleotide or phospholipid.

Still another aspect of the invention provides a kit comprising a solid phase extraction (SPE) device comprising a solid phase extraction (SPE) device comprising a packed alumina sorbent and instructions for use in accordance with the methods of the invention.

### BRIEF DESCRIPTION OF THE DRAWINGS

FIG. 1 sets forth MALDI-TOF MS spectra of: A) a control sample comprising a mixture of four synthetic phosphopeptides (T18_{—}1P, T19_{—}1P, T43_{—}1P and T43_{—}2P; modified version of tryptic yeast enolase peptides) and non-modified yeast enolase tryptic peptides in 1:10 molar ratio; B) the four phosphopeptides retained using IMAC method; and C) the phosphopeptides retained using solid phase extraction with Alumina B sorbent according to the invention.

FIG. 2 shows a comparison of LC/MS analysis of: A) peptides extracted from a mixture of 4 phosphopeptides derived from yeast enolase tryptic peptides and non-modified enolase tryptic peptides in 1:50 molar ratio using TiO₂ SPE; and B) phosphopeptides isolated from a mixture of four phosphopeptides derived from yeast enolase tryptic peptides and non-modified enolase tryptic peptides in 1:50 molar ratio with Alumina B sorbent according to the invention.

FIG. 3 shows a comparison of LC/MS analysis of: peptides extracted from a mixture of four phosphopeptides derived from yeast enolase tryptic peptides and non-modified enolase tryptic peptides in 1:50 molar ratio using TiO₂ SPE, with 40 mg of a displacement agent added to the mixture in the loading step; and B) phosphopeptides isolated from a mixture of four phosphopeptides derived from yeast enolase tryptic peptides and non-modified enolase tryptic peptides in 1:50 molar ratio using solid phase extraction with Alumina B sorbent according to the invention, with 8 mg of the displacement agent added to the mixture in the loading step.

### DETAILED DESCRIPTION OF THE INVENTION

Definitions

Before a further description of the invention, and in order that the invention may be more readily understood, certain terms are first defined and collected here for convenience.

The term “macromolecule” includes polymers, e.g., oligomers, such as, e.g., DNA, RNA, proteins, lipids and polysaccharides, but excludes small organic molecules (typically having molecular weights of 500 Da or less). Exemplary macromolecules include peptides, phopshopeptides, polypeptides, glycopeptides, proteins, phosphoproteins, nucleic acids, oligonucletoides, polynucelotides, phospholipids, synthetic or natural polymers and mixtures thereof.

The term “functionalized macromolecule” includes macromolecules having functional groups. Functionalized macromolecules are often referred to as “analytes of interest’ in a variety of scientific, biochemical and clinical scenarios.

The term “functional group” refers to a specific structure of one or more atoms that is responsible for the chemical morphological, physiological, biochemical, or environmental behavior of a compound. One or more atoms, e.g., carbon and/or hydrogen atoms, of a macromolecule can be substituted with a functional group to yield a functionalized macromolecule of the invention. Thus, functionalized macromolecules according to the invention have functional groups including, e.g., amines, carboxylic acids, phosphonates, sulfonates, sialylates, etc. Exemplary functionalized macromolecules in accordance with the invention include compounds containing highly acidic side chains or include a phosphate group, a sulfonate group, or a sialylate group.

Functionalized macromolecules according to the invention have functional groups that are distinct from other compounds found in a sample, e.g., a biological sample. For example, in a sample comprising phosphopeptides and natural peptides, the functionalized macromolecules are the phosphopeptides. Further examples of functionalized macromolecules include, but are not limited to, phosphopeptides, sialylated glycopeptides, sulfonated peptides, sulfonated peptides, sulfonated glycopeptides, phospho-oligonucleotides, and phospholipids.

The term “highly acidic side chain” is intended to include side chains that are more acidic than the side chain of aspartic acid (pKa=3.9).

The term “solid phase extraction (SPE) device” includes traditional solid phase extraction devices such as, e.g., micro elution plates, chromatographic columns, thin layer plates, sample cleanup devices, injection cartridges, microtiter plates, chromatographic preparatory devices, e.g., “short” cleanup columns, membranes, preferably having a solid phase to which the biological analyte can be deposited as a thin film, etc. Exemplary SPE devices for use in accordance with the invention include elution plates and columns.

The terms “alumina”, “alumina sorbent” and “alumina packing materials” are used interchangeably and are intended to include alumina, which has the empiral formula of Al₂O₃. The manufactured Alumina exists in three different forms based on their pH: Alumina A means acidic (pH 4.5), Alumina B means basic (pH 9.5) and Alumina N means neutral (pH 7). Chromatographic grade Alumina is commercially available from, e.g., MP Biomedicals, Sigma Aldrich, and Cole-Partner.

The term “displacement agent” is intended to include an agent capable of removing (or displacing) a compound, e.g., a peptide, having a weaker binding affinity for an alumina sorbent than a functionalized macromolecule, e.g., a phosphopeptide. Exemplary displacement agents include one or more reagents comprising carboxylic acid moieties.

The term “sample” includes any medium containing a mixture of compounds from which a functionalized macromolecule is to be isolated. Samples include to samples that are, or derived from, biological samples comprising complex mixtures of compounds, e.g., blood, urine, spinal fluid, synovial fluid, sputum, semen, saliva, tears, and extracts and/or dilutions/solutions thereof, laboratory samples, e.g., reaction mixtures, preparative HPLC, chromatographic eluents, fractions, etc., and environmental samples.

### Overview of the Invention

The invention provides methods for selectively isolating/separating, purifying, detecting and/or analyzing a functionalized macromolecule or mixture of functionalized macromolecules using solid phase extraction (SPE) devices comprising an alumina sorbent, wherein the alumina sorbent is packed into a SPE device. The methods of the invention are capable of separating and thereby resolving complex mixtures of compounds, allowing rapid isolation/separation, purification, detection and/or analysis of component compounds of such mixtures.

Insofar as the target substance, i.e., the functionalized macromolecule, is concerned, the methods of the invention work well on polar compounds, non-polar compounds, acidic compounds, neutral compounds, basic compounds and any mixtures thereof. Thus, the functionalized macromolecules present in sample can be, e.g., peptides, phosphopeptides, polypeptides, proteins, or phosphoproteins (arising from, e.g., peptide synthesis or from biological samples, including digests of proteins or mixtures of proteins), nucleic acids, oligonucleotides or polynucleotides (e.g., from biological samples or from synthesized polynucleotides), phosopholipids, synthetic or natural polymers, or mixtures of these materials. The methods and systems of the invention are particularly advantageous in separating peptides, in particular, phosphopeptides, phospholipids and oligonucleotides.

In certain embodiments, the functionalized macromolecule is a macromolecule selected from the group consisting of a peptide, a polypeptide, a phosphopeptide, a glycopeptide, a protein, a phosphoprotein, a nucleic acid, an oligonucletoide, a polynucelotide, a phospholipid, a synthetic or natural polymer and mixtures thereof.

In one embodiment the functionalized macromolecule is selected from a peptide, phosphopeptide, polypeptide, protein, oligonucleotide, and phospholipid. In another embodiment, the functionalized macromolecule is a phosphopeptide. In another embodiment, the functionalized macromolecule is an oligonucleotide. In still another embodiment, the functionalized macromolecule is a phospholipid.

In particular embodiments, the functionalized macromolecule is a peptide, polypeptide, or protein comprising a highly acidic side chain. In other embodiments, the peptide, polypeptide or protein comprises a phosphate group, a sulfonate group or a sialylate group.

In still another embodiment, the functionalized macromolecule is a phosphopeptide, sialylated glycopeptide, sulfonated peptide or sulfonated glycopeptide.

In a specific embodiment, the peptide is a phosphopeptide. In a particular, the phosphopeptide is selected from T18_P, T19_{—}1P, T43_{—}1P and T43_{—}2P.

In another specific embodiment, the functionalized macromolecule is an oligonucleotide. In yet another specific embodiment, the functionalized macromolecule is a phospholipid.

In certain embodiments, the peptide, polypeptide, or protein is selectively isolated over an acidic peptide, a neutral peptide, or a basic peptide. In a particular embodiment, the peptide, polypeptide, or protein is selectively isolated over an acidic peptide.

In accordance with the methods of the invention, the solid phase extraction (SPE) devices are packed with an alumina sorbent. In one embodiment, the size of the alumina sorbent particles ranges from about 18 to about 32 μm.

In certain embodiments, the alumina sorbent is HPLC grade. In other embodiments, the alumina sorbent is selected from alumina A, alumina N and alumina B. In one embodiment, alumina A has a pH of about 4.5. In another embodiment, alumina N has a pH of about 7. In still another embodiment, alumina B has a pH of about 10. In particular embodiments, the alumina sorbent is alumina B.

A variety of solid phase extraction (SPE) devices can be used in a accordance with the methods of the invention. In one embodiment, the SPE device is selected from the group consisting of micro elution plates, chromatographic columns, thin layer plates, sample cleanup devices, injection cartridges, microtiter plates and chromatographic preparatory devices.

In certain embodiments, the SPE device is an elution plate, e.g., a micro elution plate. In a particular embodiment, the micro elution plate comprises 96 wells and is packed with a HPLC grade alumina sorbent. In a further particular embodiment, the alumina is alumina B. In yet another further embodiment, the size of the alumina sorbent particles ranges from about 18 to about 32 μm.

In another embodiment, the SPE device is a column, e.g., a microbore column, capillary column or nanocolumn.

The methods of the invention can be used to selectively isolate, purify and/or detect functionalized macromolecules from a variety of samples. In one embodiment, the sample is or is derived from a biological fluid selected from the group consisting of blood, urine, spinal fluid, synovial fluid, sputum, semen, saliva, tears, gastric juices and extracts and/or dilutions/solutions thereof. In certain embodiments, the sample comprises a biological mixture of compounds.

In another embodiment, the sample is or is derived from a reaction mixture, preparative HPLC, a chromatographic eluent or fraction or an environmental sample.

In certain embodiments, the sample, e.g., biological mixture is dissolved in a mixture of an acid solution/organic solution, and loaded onto the alumina sorbent. In one embodiment, the acid solution has a pH ranging from about 0 to about 4. In a further embodiment, the acid solution has a pH ranging from about 1 to about 3.

In certain embodiments, the acid solution is selected from an aqueous solution of trifluoroacetic acid, hydrochloric acid, hydrobromic acid, hydroiodic acid, sulfuric acid, sulfonic acid, phosphoric acid, para-toluenesulfonic acid, salicylic acid, tartaric acid, bitartaric acid, ascorbic acid, maleic acid, besylic acid, fumaric acid, gluconic acid, glucuronic acid, formic acid, glutamic acid, methanesulfonic acid, ethanesulfonic acid, benzenesulfonic acid, lactic acid, oxalic acid, para-bromophenylsulfonic acid, carbonic acid, succinic acid, citric acid, benzoic acid or acetic acid.

In another embodiment, the organic solution is an organic solvent or a mixture of an organic solvent and a non-organic solvent. In certain embodiments, the organic solvent is selected from acetonitrile, acetone, ethanol, methanol, 2-propanol, ether, tetrahydrofuran, 1,4-dioxane, benzene, toluene, cumene, methylene chloride, trichloromethane, carbon tetrachloride, N,N-dimethylformamide, N N-dimethylacetamide, N-methylpyrrolidin-2-one, and dimethyl sulfoxide. In one embodiment, the non-organic solvent is water.

In one embodiment, the fuctionalized compound, e.g., peptide, polypeptide, protein, oligonucleotide, or phospholipid, is adsorbed onto the alumina sorbent.

In another embodiment, the fuctionalized compound, e.g., the peptide, polypeptide, protein, oligonucleotide, or phospholipid, is eluted from the alumina sorbent using a basic mobile phase solution. In certain embodiments, the basic mobile phase solution is selected from ammonium hydroxide solution, triethylamine, or diammonium phosphate.

In still another embodiment, the sample, e.g., a biological mixture is dissolved in a solution having a first pH, the fuctionalized compound, e.g., the peptide, polypeptide, protein, oligonucleotide, or phospholipid, is separated from the sample by adsorption onto the alumina, and the fuctionalized compound, e.g., the peptide, polypeptide, protein, oligonucleotide, or phospholipid, is eluted from the alumina with a mobile phase solution having a second pH.

In certain embodiments the methods of the invention further comprise the step of adding a displacement agent at the loading step. In one embodiment, the displacement agent is a substituted carboxylic acid derivative.

In other embodiments, the methods of the invention further comprise the step of detecting the fuctionalized compound, e.g., the peptide, polypeptide, protein, oligonucleotide, or phospholipid. In a further embodiment, the detection step comprises mass spectroscopy or liquid chromatography-mass spectroscopy (LC-MS). In a further embodiment, the mass spectroscopy is MALDI-TOF spectroscopy.

In another embodiment, the peptide, polypeptide, or protein is selectively isolated over an acidic peptide, a neutral peptide, or a basic peptide. In a further embodiment, the peptide, polypeptide, or protein is selectively isolated over an acidic peptide. In still another embodiment, the selectively isolated peptide, polypeptide, or protein, is a phosphopeptide, sialylated glycopeptide, sulfonated peptide or sulfonated glycopeptide. In yet another embodiment, the oligonucleotides or phospholipids are selectively isolated.

### Solid Phase Extraction Devices

In accordance with the invention, the solid phase extraction (SPE) device comprises an alumina sorbent, which is packed into an apparatus or container, e.g., a reservoir of an elution plate, column or a cartridge. The alumina sorbent particles employed in the device include any alumina particulate matter that is capable of having at least one substance, either target or interfering, adhered thereto. One skilled in the art will be able to determine the size, shape, surface area, and pore volume of the sorbent particles without undue burden or experimentation and without departing from the scope of the invention.

The alumina sorbent in accordance with the invention includes HPLC grade alumina (Al₂O₃) sorbent. Exemplary types of alumina for use in accordance with the invention include: Alumina A, Alumina N and Alumina B. Alumina A has a surface pH of about 4.5, Alumina N has a surface pH of about 7 and Alumina B has a surface pH of about 10. In particular embodiments of the invention, the use of basic surface pH, such as that provided by Alumina B, in combination with strong acid loading solutions (pH<1) provides advantageous selectivity for peptides, phosphopeptides, polypeptides, proteins, oligonucleotides, or phospholipids having a phosphate, sulfonate, or sialylate group, with a dramatic reduction in non-specific binding from compounds without such functionalities.

For samples with high degrees of complexity such as whole cell lysate digested with proteolytic enzymes, the selectivity of Alumina B toward fuctionalized compounds, e.g., phosphopeptides can be further enhanced using a displacement agent. Suitable displacement agents comprise one or more reagents containing a carboxylic acid functionality, in particular substituted carboxylic acids. An exemplary displacement agent for use in accordance with the methods of the invention is Enhancer™, available from Waters Corporation (Milford, Mass.).

The amount of the alumina sorbent packed in the reservoir of the container varies depending on the bulk density of particles or the concentration of the sample. In various embodiments of the invention, the amount packed ranges from about 30 to about 500 mg, preferably from about 50 to about 300 mg, based on a volume of about 3 mL in each case.

The alumina sorbent particles employed in the device may additionally include any particulate matter that is capable of having at least one substance, either target or interfering, adhered thereto. Illustrative examples of additional sorbent particles that may be employed in the invention include, but are not limited to: ion exchange sorbents, reverse phase sorbents, and normal phase sorbents. More particularly, the additional sorbent particles may be an inorganic material such as SiO₂ or an organic polymeric material such as poly(divinylbenzene). In some embodiments, the additional sorbent particles may be treated with an organic functional group such as a C₂ -C₂₂, preferably C₈-C₁₈ functional group. One skilled in the art will be able to determine the size, shape, surface area, and pore volume of the additional sorbent particles, and make other modifications to suit specific applications without undue burden and without departing from the scope of the invention.

The shape and construction material of the apparatus or container are not particularly limited as long as the container is insoluble in the organic solvent used as the eluent and impurities do not dissolve out from the container itself during the operation of solid phase extraction. Examples of the construction material for the cartridge or column include inorganic materials such as stainless steel and glass, and synthetic resin materials such as polyethylene, polypropylene and polyether ether ketone.

In one embodiment of the invention, the container or apparatus comprises a cylindrical container. In certain embodiments, the cylindrical container comprises a chromatography column into which a bed of alumina sorbent is packed. Chromatography columns include, e.g., preparative columns, semi-preparative columns, microbore columns, capillary columns, nanocolumns.

In certain embodiments, the ends of the containers are stoppered by a porous plate comprising a frit or filter to prevent outflow of the packing material. In certain embodiments, the diameters of the pores of the plate range from about 5 to about 200 pm, preferably from about 10 to about 50 μm. The construction material of porous plate filter or frit is not particularly limited and examples thereof include stainless steel, glass, polyethylene and polytetrafluoroethylene. The frit or filter is fastened by a cap having a hole.

In certain embodiments, the container, e.g., cartridge, itself has no connector for facilitating fluid flowing through the cartridge. However, the container is advantageously designed to accommodate an end fitting. The end fitting advantageously comprises a joint connector together with a frit or a filter. Thus, the container can be connected directly to a fluid reservoir and the end fitting allows fluid from the fluid reservoir to flow through the container.

The alumina packing material and associated devices of the invention are not limited to any particular application. However, as described above, they are well suited for use in solid phase extraction methods for isolating and/or detecting an analyte, e.g., a phosphopeptide, an oligonucleotide and/or a phospholipid in a sample.

The alumina packing material and associated devices of the invention can also be used for sample pretreatment, e.g., in a column switching method. Various methods are known for sample pretreatment by column switching.

These methods include, for example, methods whereby a column or cartridge for solid phase extraction is fixed in front of a column for analysis; impurities or contaminants present together are adsorbed by the column or cartridge for solid phase extraction to feed only necessary fractions to the column for analysis; and the column or cartridge used for the pretreatment is washed with another eluent by changing over the value while continuing the analysis. In another method, only necessary fractions are once adsorbed to the column or cartridge for solid phase extraction and after interfering components are flowed out, the valve is switched over to introduce the adsorbed components newly with another eluent into the column for analysis.

The invention provides for conically shaped packed beds contained between spherical filters which enhance the performance of solid phase extraction devices by allowing target compounds to be both efficiently retained and eluted. The larger first spherical filter provides a surface area that is approximately two times the area of an equivalently sized cylindrical filter. For example, surface area of the top half of a sphere of a diameter of 0.1″ is equal to the surface area of the top of a disk of diameter 0.14″. The smaller second filter helps to minimize the amount of alumina sorbent needed to create a bed length that will be free of adverse imperfections.

Thus, in one embodiment, the SPE device comprises a packed bed of alumina sorbent particles in a cylindrical container having a tapered internal wall geometry. Two porous filter elements, one larger and one smaller, given the tapered geometry, are at each end of the cylindrical container. A reservoir is position upstream of the first porous filter (e.g., the larger porous filter) and an exit spout is positioned downstream of the second porous filter (e.g., the smaller porous filter). The spout directs fluids exiting the device into a suitable collection container. The tapered internal wall geometry serves to provide an upstream first porous filter having a large filtration area for capturing foreign sample particulates prior to them reaching the alumina sorbent bed, and a smaller downstream filter, while allowing minimal internal void volume between the alumina sorbent bed and the first filter.

In a related embodiment, the SPE device in accordance with the invention comprises a packed bed of alumina sorbent in a well-shaped container, e.g., a well in a multi-well plate. As in the tapered cylindrical container embodiment, spherical porous filters can be used, which are easy to handle during assembly and require no special insertion tooling. Moreover, the spherical filters self-align when placed into the well cavity, and seal against the cavity wall easily without the need for close dimensional tolerances between the spherical filters and the internal surface of the well. The tapered well design also allows for a range of sorbent masses within the same SPE device, thereby providing flexibility to tailor the device for different applications. This is accomplished by simply changing the diameter of the spherical porous filters, thereby positioning the filters and packed sorbent bed either higher or lower within the tapered device without having to alter the well cavity.

The cylindrical container has a tapered internal wall geometry and the tapered well geometry provides an alumina sorbent bed shape that has considerably less tendency to form undesirable flow channels, thereby preventing sample components bypassing the bed without adequately contacting the alumina sorbent particles. Fluids passing through the alumina sorbent bed during the conditioning and loading steps act to consolidate the tapered packed bed, resulting in a consistently formed bed structure. These configurations promote efficient contact between the sample and the sorbent bed, less chance for sample breakthrough during loading, and efficient use of wash and elution fluids.

The devices of the invention provide a large bed height to top bed diameter ratio using a small sorbent mass. The large bed height to bed diameter ratio enhances the retention of target compounds and helps to prevent breakthrough of these compounds during the load and wash steps. In SPE the first filter and the top of the sorbent bed acts like a depth filter in removing insoluble sample components. The larger diameter for the upper portion of the bed and larger diameter first filter allows the device to draw through larger sample volumes than could be drawn through a device having an upper bed diameter the same as the lower bed diameter before obstructions will occur. The smaller second filter increases the bed height to bed diameter ratio for a given mass of sorbent while reducing the hold up volume of the device which minimizes required elution volumes.

In other embodiments, the invention provides solid phase extraction devices, e.g., capillaries, comprising channels, and methods of using the same for extracting an analyte from solution. The term “channel” encompasses but is not limited to the various forms of conventional capillary tubing that are used for applications such as chromatography and capillary electrophoresis. Thus, the term also encompasses other open channels of similar dimensions, having one or more capillary flow passageways, each having an inlet and outlet. Examples include a capillary tube, a bundle of tubes, a solid block or chip having one or more passageways or flow cells running therethrough, e.g., a microfluidics device such as those associated with BiaCore, Inc. (Piscataway, N.J.), Gyros, Inc. (Uppsala, Sweden), Caliper Technologies, Inc. (Mountain View, Calif.) and the like. The passageways can have linear or non-linear central axes, e.g., they can be coiled, curved or straight. The cross-sectional geometry of the passageway is not critical, so long as it allows the channel to function as an extraction channel. For example, capillary tubes having a round cross-sectional geometry work well and can be purchased from a number of vendors. However, other geometries, such as oval, rectangular or another polygonal shape, or a combination of such shapes, can also be employed.

In certain embodiments the extraction channels are open; i.e., the channels are not packed with resin or other forms of chromatographic beads used in conventional chromatography. Rather, the channel is open and the extraction phase consists of an alumina extraction surface bound either directly or non-directly to the channel surface. The extraction process involves flowing solvent, such as sample solvent, desorption solvent, and optionally a wash solvent, through the open channel, or some portion of the channel. In certain embodiments, the open channel is a capillary, e.g., an extraction capillary.

Whatever the geometry of the channel, the dimensions should be such that analyte is able to effectively interact with the extraction surface during the course of the extraction process and fluids can be moved through the channel, e.g., pumped through the channel. Thus, with large biological macromolecules it is desirable that the ratio of channel surface area to channel volume per a length of channel is high enough to allow for effective diffusion of analyte to the surface during the time the sample is in the channel. In general, the greater the ratio of the channel perimeter (or circumference, in the case of a round channel) to internal cross-sectional area, the greater the transport or diffusion of analyte from sample solution to extraction surface. In the case of a round channel, this simply means that the smaller the internal diameter of the capillary the more effective the transport will be for a given length of capillary and under given conditions of sample volume, flow rates, residence times, etc. Of course, the trade-off for increased interaction with the capillary extraction surface is lower flow capacity with lower channel perimeter and a lower extraction capacity due to less surface area. In addition, if the perimeter (e.g., circumference) is very small there could be problems with clogging due to any particulate matter or the like that might be present in a sample, such as a crude cell lysate. One of skill in the art would be able to readily select an appropriate capillary having dimensions that allow for effective transport of analyte to the extraction surface while maintaining adequate solution flow and extraction capacity.

As an alternative to increasing ratio of extraction surface area to capillary volume, the transport of bulky analtye to the extraction surface can be improved by lengthening the channel, the flow rate through the channel can be increased, the sample can be passed back and forth through the channel multiple times, the sample can be allowed to incubate in the channel for a period of time, and/or the sample solution can be agitated as it flows through the channel (by introducing tortuosity into the flow path, e.g., by coiling the capillary), by introducing beads or other features into the capillary, etc. Note that a feature such as a bead that is introduced into a capillary to modulate flow properties should not be penetrable to the analyte or introduce unswept dead volumes that would be contrary to the free flow of solvent through the open channel.

The inner walls of the channel can be relatively smooth, rough, textured or patterned. Preferably, they are relatively non-porous. The inner surface can have irregular structure such as is described by Paul Kenis, et al., (2000) Acc. Chem. Res., 33:84 and Paul Kenis, et al., (1999) Science, 285:83. The tube can contain a monolith structure provided that it has channels for liquid passage. Whatever the internal structure of the capillary, it is important to minimize dead volumes or areas that prevent effective removal of solution from the capillary prior to the desorption step in an extraction process.

The capillary channel may be composed of a number of different materials. These include alumina, fused silica, polypropylene, polymethylmethacrylate, polystyrene, (nickel) metal capillary tubing, and carbon nanotubes. Polymeric tubes are available as straight tubing or multihole tubing (Paradigm Optics, Inc., Pullman, Wash.). Functional groups may be needed on the capillary tube surface to perform solid phase extraction. Methods to attach chemical groups to polymers are described in the following organic synthesis texts, and these texts are hereby incorporated by reference herein in their entireties, Jerry March ADVANCED ORGANIC CHEMISTRY, 3rd ed., Wiley Interscience: New York (1985); Herbert House, MODERN SYNTHETIC REACTIONS, 2.sup.nd ed., Benjamin/Cummings Publishing Co., California (1972); and James Fritz, et al., ION CHROMATOGRAPHY, 3rd, ed., Wiley-VCH, New York (2002); and ORGANIC SYNTHESIS ON SOLID PHASE, F. Dorwald Wiley VCH Verlag Gmbh, Weinheim 2002. Nickel tubing is available from Valco Instrument, Inc., Houston, Tex.

The extraction channels of the invention can be characterized in terms of their channel aspect ratio. The “channel aspect ratio” is the ratio of channel length to average channel inner diameter. For example, an extraction capillary having a length of 1 meter and an inner diameter of 100 microns has a channel aspect ratio of about 10,000. The channel aspect ratio of the capillary channels of this invention are typically in the range of from 10 to 1,000,000, e.g., in a range having a lower limit of 10, 100, 1000, 10,000, or 100,000, and an upper limit of 1000, 10,000, 100,000 or 1,000,000.

The volumes of extraction channels can vary depending upon the nature of the analyte, the extraction chemistry, the channel capacity, and the amount of purified analyte required for the particular application. In various embodiments, the volume of the extraction column can be on the order of liters, milliliters, microliters, or nanoliters.

In embodiments of the invention employing capillary tubing, the tubing is beneficially coated with a flexible coating material, typically a polymer or resin. Preferred coating materials include polyimide, silicone, polyacrylate, aluminum or fluoropolymer, especially semiconductor grade polyimide.

In other embodiments, the channel has the property of allowing movement and removal of liquid. In this respect, the channel could contain secondary structures, including roughness and protrusions or even beads or monolith structure as long as the channels that are formed in the secondary structure do not result in unswept volumes that substantially impact performance. Details of encapsulated and monolith structures are provided in Ronald Majors, 2002 Pittsburgh Conference, Part I, LC/GC Europe, April 2002, pp 2 15.

Because of the nature of the flow path in an open channel, it is possible to capture, purify and concentrate molecules or groups of molecules that have a relatively large structure compared even to a protein. An extraction channel with the appropriate binding functionality on the surface can bind and extract these structures without problems such as shearing or (frit or backed bed) filtration.

Solid phase extraction devices are known in the art and are described at least in the following U.S. Pat. No. 5,911,883; 5,688,370; 5,595,649; 5,472,600; 5,415,779; and 5,279,742.

### Micro-Elution Plate

In certain embodiments, the solid phase extraction devices utilized in the invention comprise a micro elution plate. In these embodiments, the bed of alumina sorbent particles is packed into the micro-elution plate.

In one embodiment, the micro-elution plate comprises a plurality of wells. In certain embodiments the number of wells ranges from about 25 to about 250; in certain instances about 90 to about 100; in certain instances 96. In such embodiments, the alumina is packed into the well, advantageously on top of a frit. Another frit is advantageously placed on top to created a frit alumina frit structure within the well.

In certain embodiments, the micro-elution plate comprises a plurality of wells packed with about 0.5 mg to about 5.0 mg of alumina B. In other embodiments, the wells are packed with about 2.0 mg to about 3.0 mg of alumina B.

In advantageous embodiments, the wells have a tapered internal geometry that facilitates inclusion of an upstream first porous filter having a large filtration area for capturing foreign sample particulates prior to them reaching the alumina sorbent bed, and a smaller downstream filter, while allowing minimal internal void volume between the alumina sorbent bed and the first filter. The effective filtration area of the spherical filter is based on the surface of the exposed hemispherical section of the filter, which is larger than the area of a flat disc filter of equal diameter by a factor of 2.

The spherical filters are easy to handle during assembly and require no special insertion tooling. Moreover, the spherical filters self-align when placed into a tapered well cavity seal against the cavity wall easily without the need for close dimensional tolerances between the spherical filters and the internal surface of the well. The tapered well design also allows for a range of alumina sorbent masses within the same SPE device, thereby providing flexibility to tailor the device for different applications. This is accomplished by simply changing the diameter of the spherical porous filters, thereby positioning the filters and packed alumina sorbent bed either higher or lower within the tapered device without having to alter the well cavity.

The tapered well geometry differs from conventional cylindrical designs, because it results in a sorbent bed shape that has considerably less tendency to form undesirable flow channels, thereby preventing sample components bypassing the bed without adequately contacting the alumina sorbent particles. Fluids passing through the alumina sorbent bed during conditioning and loading steps act to consolidate the tapered packed bed, resulting in a consistently formed bed structure.

This results in efficient contact between the sample and the alumina sorbent bed, less chance for sample breakthrough during loading, and efficient use of wash and elution fluids. This embodiment of the invention enables the retention of target compounds with a wide range of chromatographic polarity with elution in volumes that are much reduced from the current state of the art for solid phase extraction. This reduction in elution volume provides a solution containing the target compounds that can be diluted with an aqueous solution while still maintaining the high sample concentrations required for analysis.

In another embodiment, the device further comprises a transport and fluid delivery means configured to receive reaction vessels therein and to align said reaction vessels with the plurality of wells in the micro-elution plate.

The invention also provides a mmethod of performing solid phase extraction, where the volume of elution solvent is sufficiently small so as to eliminate the need for an evaporation step. The method involves elution of the target compounds in a minimal volume of organic solvent, typically 10-40 μL, which is then diluted with a highly aqueous fluid to form an aqueous organic sample mixture. This mixture is suitable for direct analysis by HPLC, thereby eliminating the time, expense, and potential sample losses associated with evaporation and reconstitution steps, while still maintaining a high degree of target compound(s) concentration.

Specifically, the inventive method comprises the steps of providing the above-mentioned SPE device, and isolating target substances from interfering components in a sample medium, wherein the target substances are substantially eluted in less than 50 μL volume.

In one embodiment of the invention, the isolating step of the invention preferably includes conditioning the SPE device with an organic solvent; equilibrating the SPE device with an aqueous solution; adding a prepared sample containing the target substances and interfering components to the SPE device; washing the SPE device with an aqueous solution to remove interfering components; and eluting the adsorbed target substances.

In another embodiment, the aqueous diluent is added directly through the SPE device, while still on the processing station used to perform the SPE fluid transfers. In this way, residual elution solvent is swept through the device into the collection container, where it is diluted by the aqueous fluid and mixed by the gentle air stream that is drawn through the well at the end of the transfer. This approach has the advantage of eliminating the need for a separate pipetting operation to perform the dilution step.

The invention can be used to purify samples prior to analysis, i.e., to isolate a desired target substance from an interfering substance in a sample medium, using a smaller elution volume than heretofore possible with prior art SPE devices. Specifically, and in a preferred embodiment, the method of the invention comprises first conditioning the SPE device with any organic solvent that is capable of wetting the surfaces of the device and alumina sorbent particles. Illustrative examples of organic solvents that can be used in the conditioning step include, but are not limited to: polar or non-polar organic solvents such as methanol and acetonitrile. The amount of organic solvent used to condition the SPE device may vary and is not critical to the invention so long as the organic solvent is used in an amount that wets the SPE device. Note that the solvent used in this step of the inventive method also serves to remove contaminants from the SPE device.

After the conditioning step, an aqueous solution is used to equilibrate the conditioned SPE device. The amount of aqueous solution used to equilibrate the SPE device may vary and is not critical to the invention.

Extraction Methods

Methods of the invention typically involve adsorbing an analyte of interest from a sample solution onto the alumina extraction surface of a solid-phase extraction device, substantially evacuating the sample solution while leaving the adsorbed analyte bound to the alumina extraction surface, and eluting the analyte from the channel in a desorption solution. The desorbed analyte can be collected, and is typically analyzed by any of a number of techniques, some of which are described in more detail herein. In some embodiments, the alumina extraction surface is washed prior to elution. The extraction process generally results in the enrichment, concentration, and/or purification of an analyte or analytes of interest.

In general, the methods involve introducing a sample solution containing the analyte of interest into a container, e.g., a column, well, channel, etc., packed with a bed of alumina sorbent in a manner that permits the analyte to interact with and adsorb to an extraction surface of the alumina sorbent. The sample solution enters the packed bed extraction container through one end and passes through the container, eventually exiting the channel through either at the same end of the of the container end. Introduction of the sample solution into the packed bed container can be accomplished by any of a number of techniques for driving or drawing liquid through a chromatographic device. Examples include use of a pump (e.g., a syringe, pressurized container, centrifugal pump, electrokinetic pump, or an induction based fluidics pump), gravity, centrifugal force, capillary action, or gas pressure to move fluid through the capillary. The sample solution is preferably moved through the container at a flow rate that allows for adequate contact time between the sample and alumina extraction surface.

The sample solution can be passed through the container more than one time, either by circulating the solution in the same direction two or more times, or by passing the sample back and forth two or more times. In some embodiments it is important that the pump be able to pump air, thus allowing for liquid to be blown out of the packed bed extraction column or extraction channel. Preferred pumps have good precision, good accuracy and minimal hysteresis, can manipulate small volumes, and can be directly or indirectly controlled by a computer or other automated means, such that the pump can be used to aspirate, infuse and/or manipulate a predetermined volume of liquid.

The required accuracy and precision of fluid manipulation will vary depending on the step in the extraction procedure, the purity of the analyte desired, and the dimensions of the SPE.

In some embodiments of the invention, after the sample solution has been exposed to the extraction surface and analyte adsorbed, the sample solution is substantially eliminated from device. Although it is not always necessary to remove the sample solution from device prior to elution, it is usually desirable because it reduces the presence of unwanted contaminating species from the sample solution that end up with the eluted protein, and also facilitates control of the desorption solution in the device. In some embodiments of the invention, the residual sample solution can be more thoroughly removed from the device by blowing air or gas through. However, this is usually not necessary since typically a wash step is performed between the sample loading and elution steps in the purification.

The sample solution can be any solution containing an analyte or analytes of interest. Still, it is often useful to clarify a crude sample prior to introduction into the device , e.g., by centrifugation or filtration. Examples of sample solutions would include cell lysastes, serum-free hyridoma growth medium, tissue or organ extracts, biological fluids, cell-free translation or transcription reactions, or organic synthesis reaction mixtures. In some cases the sample solution is the analyte in a solvent used to dissolve or extract the analyte from a biological or chemical sample. The solvent should be sufficiently weak to ensure sufficient adsorption of the analyte to the alumina extraction surface. Ideally, the adsorption is quantitative, near quantitative, or at least involves a substantial amount of the analyte. Nevertheless, the process can still be very useful where only some smaller fraction of the total analyte is adsorbed, depending upon the nature of the analyte, the amount of starting material, and the purpose for which the analyte is being processed.

In some embodiments of the invention, a container (column, cartridge, well, channel, etc.) is washed after the sample loading and prior to analyte elution. Although this step is optional, it is often desirable since it can remove contaminants from the alumina extraction surface and thus improve the purity of the eluted product. A wash solution (i.e., a rinse solution) should be employed that will wash contaminants from the alumina extraction surface while, to the extent possible, allowing the adsorbed analyte to remain adsorbed to the alumina extraction surface. The wash solution should also be one that does not damage the analyte molecule or extraction surface. In some cases, such as where the analyte is a protein or protein complex, a wash solution is used that does not denature or degrade the analyte, facilitating recovery of functional native protein.

The exact nature and composition of the wash solution can vary, and will to some extent be determined by the nature of the analyte, the alumina extraction surface, and the nature of the adsorption. Ideally, a wash solution will be able to solubilize and/or wash contaminants from the column or channel and extraction surface while leaving the adsorbed analyte bound. To some extent, selection of the wash solution will depend upon the relative importance of sample purity vs. sample recovery.

Prior to elution of the adsorbed analyte from an extraction column or channel, it is often desirable to purge any residual solution from the container; i.e., to displace residual solution from the column or channel. This can be accomplished by passing a gas such as air or nitrogen through the column or channel. More effective purging can in some cases be achieved by blowing gas through the column or channel for some amount of time sufficient to achieve the desired extent of purging. This residual solution will typically be the wash solution if such is used, or the sample solution if there is not wash step. In some embodiments a purge step can be performed both before the wash step (e.g., to remove residual sample solution) and after the wash step, but purging is normally not necessary prior to the wash step. In certain embodiments, multiple wash steps are employed. For example, in some embodiments an extra D₂O wash is employed prior to elution in a deuterated solvent. Purging can be effected after such extra steps if desired.

In one embodiment the objective is to substantially remove all bulk liquid from the column or channel, without dehydrating or desolvating the alumina extraction surface. The extraction surface and any bound analyte, e.g., a bound protein, remain hydrated and in their native state, while any bulk solution that could detract from the ultimate purity and concentration of the eluted analyte are removed. This can be accomplished by blowing a gas through the column or channel for a suitable period of time. The amount of time will vary depending upon the nature of the extraction surface, the nature of the solution in the capillary, etc.

The extent of displacement of fluid from the column or channel can vary depending upon the requirements of the particular extraction protocol and system used. For example, as a result of the purge step the extraction column or channel is at least 20% free of bulk liquid, or at least 30% free of bulk liquid, or at least 40% free of bulk liquid, or at least 50% free of bulk liquid, or at least 60% free of bulk liquid, or at least 70% free of bulk liquid, or at least 80% free of bulk liquid, or at least 90% free of bulk liquid, or at least 95% free of bulk liquid, or at least 98% free of bulk liquid, or at least 95% free of bulk liquid, or substantially free of bulk liquid.

Thus, in one embodiment the invention provides an extraction column or channel containing a bound analyte that is substantially free of bulk liquid. In particular, the bound analyte can be a biomolecule, such as a biological macromolecule (e.g., a polypeptide, peptide or protein). In preferred embodiments the analyte is a protein or protein-containing complex. While substantially free of bulk solution, the analyte and/or extraction surface can be fully hydrated. In the case of a biomolecule such as a protein, this hydration can stabilize the binding interaction and the structural and functional integrity of the molecule. An extraction capillary containing a bound, hydrated biomolecule but otherwise substantially free of bulk water can be prepared by purging the column or channel for a suitable amount of time. It can be important not to over-dry the column or channel, since this could cause the denaturation of a bound biomolecule, and could prevent or hinder recovery of the functional molecule. Under the proper conditions, the column or channel and bound analyte will be stable for a substantial period of time, particularly if the proper hydration is maintained. The column or channel is useful for providing a pure, concentrated sample of the adsorbed analyte, which can be recovered by using the appropriate elution protocol as described herein. In some embodiments the alumina extraction surface is 3-dimensional.

Finally, after any optional wash and/or purge steps have been performed, the adsorbed analyte is eluted from the column or channel via desorption into a desorption solution. The desorption solution can be drawn or driven in and out of the column or channel by the same or different mechanism as used for the sample solution and/or wash solution. The amount of desorption solution used will determine the ultimate concentration of the eluted analyte.

In general, sensitivity and selectivity can be improved by increasing the number of passes of sample solution and/or desorption solution through the column or channel, and/or by decreasing flow rate. Both result in longer exposure of the analyte to the alumina extraction surface. However, both will also result in the extraction process taking longer, so there can be a trade-off of lower throughput for the improved sensitivity and selectivity. Depending upon the relative importance of sensitivity and selectivity vs. throughput, the appropriate number of passages and flow rate can be selected.

In some embodiments, the multiple-pass solution is passed through at least some substantial portion of the extraction column or channel at least twice, and in certain embodiments it can be passed through at least four times, at least eight times, at least twelve times, or even more, in order to achieve the desired effect. Multiple passages can be achieved by passing the solution multiple times through the column or channel in the same direction, or can be achieved by reversing the flow of solution so that it flows back and forth through the column or channel.

The wash solution and desorption solvent also can be introduced from either end and may be moved back and forth in the column or channel. They can include combination of a column or channel and a pump for gas and liquids such as conditioning fluid, sample, wash fluid, and desorption fluid. The pump can be, e.g., a syringe (pressure or vacuum), pressure vessel (vial), or centrifugation device. The pumping force is preferably on the bulk fluid and preferably not due to electro osmotic force; fluid is moved through the column or channel in a controlled manner. Generally, this means that the volume of liquid acted upon is controlled through positive displacement or movement of a specified volume, timing of the pumping action or through control of the volume of the fluid pumped through the column or channel. Examples of suitable pumps include syringe or piston, peristaltic, rotary vane, diaphragm, pressurized or vacuum chamber, gravity, centrifugal and centrifugal force, capillary action, piezo-electric, piezo-kinetic and electro-kinetic pumps.

The invention can be used to purify samples prior to analysis, i.e., to isolate a desired phosphopeptide or an oligonucleotide in a sample medium using a smaller elution volume. Specifically, in one embodiment, the invention provides a method of first conditioning the SPE device with any organic solvent that is capable of wetting the surfaces of the device and alumina sorbent particles. Illustrative examples of organic solvents that can be used in the conditioning step include, but are not limited to: polar or non-polar organic solvents such as high purity water, methanol and acetonitrile. The amount of organic solvent used to condition the SPE device may vary and is not critical to the invention so long as the organic solvent is used in an amount that wets the SPE device. Note that the solvent used in this step also serves to remove contaminants from the SPE device.

After the conditioning step, an aqueous solution is used to equilibrate the conditioned SPE device. The amount of aqueous solution used to equilibrate the SPE device may vary and is not critical to the invention.

A prepared sample containing at least one phosphopeptide is then added to the SPE device using conventional means that are well known to those skilled in the art. Next, an aqueous solution of trifluoroacetic acid, acetonitrile, water, and combinations thereof, is employed to remove the rest of the sample from the SPE device and thereafter the target substance, which is adsorbed onto the alumina sorbent particles, is eluted from the SPE device using an organic eluant that is capable of removing the adsorbed target substances from the SPE device.

Next, an aqueous solution is employed to remove the interfering substance from the SPE device and thereafter the target substance, which is adsorbed onto the alumina sorbent particles, is eluted from the SPE device using an organic eluent that is capable of removing the adsorbed target substances from the SPE device.

In certain embodiments, the process of the invention provides a solid phase extraction device that is used to (a) precipitate the compounds of interest onto the device and (b) leverage the large surface area thereof, e.g., a packed matrix, to support the precipitated compound of interest while impurities are washed away. The method, in effect, changes the alumina sorbent into a support matrix for thin film deposition. In this manner, undesired components or impurities can be solubilized completely and rinsed through or off the device with wash solutions that are (a) strong enough to remove the impurities, but (b) not the compounds of interest (e.g., proteins, peptides, or phosphopeptides) which are retained as a thin film precipitate on the surface, or in the pores of the alumina sorbent. The precipitation step can be accomplished by various methods appropriate for the specific application. In one embodiment, vacuum may be used to strip solvent and cause precipitation on the alumina sorbent. Alternatively, the compounds of interest can be precipitated after being adsorbed on the alumina sorbent surface by the delivery of a stream of gas or by delivery of a wash solvent that will simultaneously exchange the initial wash solvent and cause the precipitation (in effect, a trituration step).

Regarding peptides a crude, synthetic peptide sample is adsorbed to an alumina solid support. The support is washed with water, acetonitrile or trifluoroacetic acid (“TFA”), or combinations thereof, including TFA/Acetonitrile/water solution. Salts and other impurities are washed through the column to waste. At this point, all components of the remaining sample mixture are partitioned between the solid phase alumina sorbent and the residual solvent (water or TFA/water). However, the equilibrium is far to the side of the sorbent.

In the second step, a drying step is used to strip solvents (water, trifluoroacetic acid, and volatile organics) from the alumina sorbent. After drying, there is no longer a partitioning system and the sample components are adsorbed to, or form a solid mixture with, the alumina sorbent. This drying step causes the compounds of interest and the impurities to precipitate on the surface of the SPE particles. At this stage, the compound of interest and the impurities are in the solid form, supported on the surface or pores of the matrix.

In a third step, solvents are chosen, e.g., such that they can impurities which are not the desired peptide product. Selection of such solvents are within the skill of those in the art. With peptides or proteins as a desired biological analyte(s), such solvents as trifluoroacetic acid, HCl, HBr, sulfuric acid, nitric acid, phorphoric acid, acetonitrile, acetone, or methanol, and combinations thereof, may be used to wash through the column and carry away the impurities and leave the insolubilized/precipitated peptide trapped on the solid phase surface.

In a further step, a wash solvent is used to elute the compound of interest. This final wash solvent solubilizes the compound of interest under conditions which cause desorption from the alumina.

Step and Multi-Dimensional Elutions

In some embodiments of the invention, desorption solvent gradients, step elutions and/or multidimensional elutions are performed. The use of gradients is well known in the art of chromatography, and is described in detail, for example in a number of the general chromatography references cited herein. As applied to the extraction channels of the invention, the basic principle involves adsorbing an analyte to the alumina extraction surface and then eluting with a desorption solvent gradient. The gradient refers to the changing of at least one characteristic of the solvent, e.g., change in pH, ionic strength, polarity, or the concentration of some agent that influence the strength of the binding interaction. The gradient can be with respect to the concentration of a chemical that entity that interferes with or stabilizes an interaction, particularly a specific binding interaction.

Gradients used in the context of the invention can be gradual or can be added in step. Step elutions are particularly applicable, particularly when segments of desorption solvent bounded by air and/or some other immiscible fluid are employed. In one embodiment, two or more plugs of desorption solvent varying in one or more dimension are employed. For example, the two or more plugs can vary in pH, ionic strength, hydrophobicity, or the like. The segment can have a volume greater than the capillary or less, i.e., a tube enrichment factor of greater than one can be achieved with each plug. Optionally, the column or channel can be purged with gas prior to introduction of one or more of the desorption solvent plugs. In one embodiment, the plugs are introduced and ejected from the same end of the capillary. The plug is passed back and forth through the column one or more times. As described elsewhere herein, in some cases the efficiency of desorption is improved by lowering the flow rate of desorption solvent through the capillary and/or by increasing the number of passages, i.e., flowing the solvent back and forth through the capillary.

In another embodiment, a series of two or more plugs of desorption solvent is run through the column or channel in sequence, separated by segments of air. In this embodiment, the air-separated segments vary in one or more dimensions. The plugs of solvent can enter and leave the capillary from the same or different ends, or they can enter the capillary at one end and leave from the other.

Solvents

Extractions of the invention typically involve the loading of the peptide, polypeptide, or protein analyte in a sample solution, an optional wash with a rinse solution, and elution of the analyte into a desorption solution. In preferred instances, the analyte is a phosphopeptide. With regard to the sample solution, it typically consists of the analyte dissolved in a solvent in which the analyte is soluble, and in which the analyte will bind to the alumina extraction surface. Preferably, the binding is strong, resulting in the binding of a substantial portion of the analyte, and optimally substantially all of the analyte will be bound under the loading protocol used in the procedure. The solvent should also be gentle, so that the native structure and function of the analyte is retained upon desorption from the alumina extraction surface. Typically, the solvent is an aqueous solution, typically containing a buffer, salt, and/or surfactants to solubilize and stabilize the analyte. Examples of sample solutions include cells lysates, hybridoma growth medium, cell-free translation or transcription reaction mixtures, extracts from tissues, organs, or biological samples, and extracts derived from biological fluids.

It is important that the sample solvent not only solubilize the analyte, but also that it is compatible with binding to the alumina extraction phase. Depending upon the nature of the sample and extraction process, other constituents might be beneficial, e.g., reducing agents, detergents, stabilizers, denaturants, chelators, metals, etc.

A wash solution, if used, should be selected such that it will remove non-desired contaminants with minimal loss or damage to the bound analyte. The properties of the wash solution are typically intermediate between that of the sample and desorption solutions.

Desorption solvent can be introduced as either a stream or a plug of solvent. If a plug of solvent is used, a buffer plug of solvent can follow the desorption plug so that when the sample is deposited on the target, a buffer is also deposited to give the deposited sample a proper pH. The deposited material can then be analyzed, e.g., by deposition on an SPR chip.

The desorption solvent should be just strong enough to quantitatively desorb the analyte while leaving strongly bound interfering materials behind. The solvents are chosen to be compatible with the analyte and the ultimate detection method. Generally, the solvents used are known conventional solvents. Typical solvents from which a suitable solvent can be selected include ammonium hydroxide, triethylamine, diammonium phosphate, methylene chloride, acetonitrile (with or without small amounts of basic or acidic modifiers), methanol (containing larger amount of modifier, e.g. acetic acid or triethylamine, or mixtures of water with either methanol or acetonitrile), ethyl acetate, chloroform, hexane, isopropanol, acetone, alkaline buffer, high ionic strength buffer, acidic buffer, strong acids, strong bases, organic mixtures with acids/bases, acidic or basic methanol, tetrahydrofuran and water. The desorption solvent may be different miscibility than the sorption solvent.

In the case where the extraction involves binding of analyte to a specific cognate ligand molecule, e.g., an immobilized metal, the desorption solvent can contain a molecule that will interfere with such binding, e.g., imidazole or a metal chelator in the case of the immobilized metal.

Purification of Classes of Proteins

The analytes or compounds present in the mixture can be, e.g., peptides or polypeptides (e.g., from peptide synthesis or from biological samples, including digests of proteins or mixtures of proteins), nucleic acids or polynucleotides (e.g., from biological samples or from synthesized polynucleotides), synthetic or natural polymers, or mixtures of these materials. The types of compounds are limited only by the chromatographic methods selected for compound separation, as described herein. In certain preferred embodiments, an analyte to be detected, analyzed, or purified is a peptide, polypeptide, or protein, in particular, a phosphopeptide.

In certain embodiments, the SPE of the invention is used to extract and/or process multi-protein complexes. This is accomplished typically by employing a sample solution that is sufficiently non-denaturing that it does not result in disruption of a protein complex or complexes of interest, i.e., the complex is extracted from a biological sample using a sample solution and extraction conditions that stabilize the association between the constituents of the complex.

In some embodiments, multi-protein complex is adsorbed to the extraction surface and desorbed under conditions such that the integrity of the complex is retained throughout. That is, the product of the extraction is the intact complex, which can then be collected and stored, or directly analyzed (either as a complex or a mixture of proteins), for example by any of the analytical methodologies described herein.

One example involves the use of a recombinant “bait” protein that will form complexes with its natural interaction partners. These multiprotein complexes are then purified through a fusion tag that is attached to the “bait.” These tagged “bait” proteins can be purified through groups attached to the surface of the capillary such as metal-chelate groups, antibodies, calmodulin, or any of the other surface groups employed for the purification of recombinant proteins. The identity of the cognate proteins can then be determined by any of a variety of means, such as MS.

It is also possible to purify “native” (i.e. non-recombinant) protein complexes without having to purify through a fusion tag. For example, this can be achieved by using as an affinity binding reagent an antibody for one of the proteins within the multiprotein complex. This process is often referred to as “co-immunoprecipitation.” The multiprotein complexes can be eluted, for example, with low pH.

In some embodiments, the multi-protein complex is loaded onto the SPE as a complex, and the entire complex or one or more constituents are desorbed and eluted. In other embodiments, one or more complex constituents are first adsorbed to the extraction surface, and subsequently one or more other constituents are applied to the extraction surface, such that complex formation occurs on the extraction surface.

In another embodiment, the SPE of the invention can be used as a tool to analyze the nature of the complex. For example, the protein complex is desorbed to the extraction surface, and the state of the complex is then monitored as a function of solvent variation. A desorption solvent, or series of desorption solvents, can be employed that result in disruption of some or all of the interactions holding the complex together, whereby some subset of the complex is released while the rest remains adsorbed. The identity and state (e.g., post-translational modifications) of the proteins released can be determined often, using, for example, MS. Thus, in this manner constituents and/or sub-complexes of a protein complex can be individually eluted and analyzed. The nature of the desorption solvent can be adjusted to favor or disfavor interactions that hold protein complexes together, e.g., hydrogen bonds, ionic bonds, hydrophobic interactions, van der Waals forces, and covalent interactions, e.g., disulfide bridges. For example, by decreasing the polarity of a desorption solvent hydrophobic interactions will be weakened—inclusion of reducing agent (such as mercaptoethanol or dithiothrietol) will disrupt disulfide bridges. Other solution variations would include alteration of pH, change in ionic strength, and/or the inclusion of a constituent that specifically or non-specifically affects protein-protein interactions, or the interaction of a protein or protein complex with a non-protein biomolecule.

In one embodiment, a series of two or more desorption solvents is used sequentially, and the eluent is monitored to determine which protein constituents come off at a particular solvent. In this way it is possible to assess the strength and nature of interactions in the complex. For example, if a series of desorption solvents of increasing strength is used (e.g., increasing ionic strength, decreasing polarity, changing pH, change in ionic composition, etc.), then the more loosely bound proteins or sub-complexes will elute first, with more tightly bound complexes eluting only as the strength of the desorption solvent is increased.

In some embodiments, at least one of the desorption solutions used contains an agent that effects ionic interactions. The agent can be a molecule that participates in a specific interaction between two or more protein constituents of a multi-protein complex. Other agents that can affect protein interactions are denaturants such as urea, guanadinium chloride, and isothiocyanate, detergents such as triton X-100, chelating groups such as EDTA, etc.

In other sets of experiments, the integrity of a protein complex can be probed through modifications (e.g., post-translational or mutations) in one or more of the proteins. Using the methods described herein the effect of the modification upon the stability or other properties of the complex can be determined.

In one embodiment, the SPE and methods of the invention are used to purify proteins that are functional, active and/or in their native state, i.e., non-denatured. This is accomplished by performing the extraction process under non-denaturing conditions. Non-denaturing conditions encompasses the entire protein extraction process, including the sample solution, the wash solution (if used), the desorption solution, the extraction phase, and the conditions under which the extraction is accomplished. General parameters that influence protein stability are well known in the art, and include temperature (usually lower temperatures are preferred), pH, ionic strength, the use of reducing agents, surfactants, elimination of protease activity, protection from physical shearing or disruption, radiation, etc. The particular conditions most suited for a particular protein, class of proteins, or protein-containing composition vary somewhat from protein to protein.

One particular aspect of the SPE technology of the invention that facilitates non-denaturing extraction is that the process can be accomplished at low temperatures. In particular, because solution flow through the SPE can be done without heating the device, the process can be carried out at lower temperatures. Lower temperature could be room temperature, or even lower, e.g., if the process is carried out in a cold room, or a cooling apparatus is used to cool the SPE. For example, SPE can be performed at a temperature as low as 0° C., 2° C., or 4° C., e.g., in a range such as 0° C. to 30° C., 0° C. to 20° C., 2° C. to 30° C., 2° C. to 20° C., 4° C. to 30° C., or 4° C. to 20° C.

Another aspect of the SPE as described herein that allows for purification of native proteins is that the extraction process can be completed quickly, thus permitting rapid separation of a protein from proteases or other denaturing agents present in a sample solution. The speed of the process allows for quickly getting the protein from the sample solution to the analytical device for which it is intended, or to storage conditions that promote stability of the protein. In various embodiments of the invention, protein extractions of the invention can be accomplished in less than 1 minute, less than 2 minutes, less than 5 minutes, less than 10 minutes, less than 15 minutes, less than 20 minutes, less than 60 minutes, or less than 120 minutes.

In another aspect, the extracted protein is sometimes stabilized by maintaining it in a hydrated form during the extraction process. For example, if a purge step is used to remove bulk liquid (i.e., liquid segments) from the SPE prior to desporption, care is taken to ensure that gas is not blown through the SPE for an excessive amount of time, thus avoiding drying out the SPE device and possibly desolvating the extraction phase and/or protein.

In another embodiment, the extraction process is performed under conditions that do not irreversibly denature the protein. Thus, even if the protein is eluted in a denatured state, the protein can be renatured to recover native and/or functional protein. In this embodiment, the protein is adsorbed to the extraction surface under conditions that do not irreversibly denature the protein, and eluting the protein under conditions that do not irreversibly denature the protein. The conditions required to prevent irreversible denaturation are similar to those that are non-denaturing, but in some cases the requirements are not as stringent. For example, the presence of a denaturant such as urea, isothiocyanate or guanidinium chloride can cause irreversible denaturation. The eluted protein is denatured, but native protein can be recovered using techniques known in the art, such as dialysis to remove denaturant. Likewise, certain pH conditions or ionic conditions can result in reversible denaturation, readily reversed by altering the pH or buffer composition of the eluted protein.

The recovery of non-dentured, native, functional and/or active protein is particularly useful as a preparative step for use in processes that require the protein to be denatured in order for the process to be successful. Non-limiting examples of such processes include analytical methods such as binding studies, activity assays, enzyme assays, X-ray crystallography and NMR.

Analytical Techniques

Extraction channels and associated methods of the invention find particular utility in preparing samples of analyte for analysis or detection by a variety analytical techniques. In particular, the methods are useful for purifying an analyte, class of analytes, aggregate of analytes, (e.g., peptides, polypeptides, proteins, and/or phosphopeptides) etc, from a biological sample, e.g., a biomolecule originating in a biological fluid. In many cases, the results of these forms of analysis are improved by increasing analyte concentration. In some embodiments of the invention the analyte of interest is a protein, and the extraction serves to purify and concentrate the protein prior to analysis. The methods are particular suited for use with label-free detection methods or methods that require functional, native (i.e., non-denatured protein), but are generally useful for any protein or nucleic acid of interest.

In certain instances, these methods are particularly suited for application to proteomic studies, the study of protein-protein interactions, and the like. The elucidation of protein-protein interaction networks, preferably in conjunction with other types of data, allows assignment of cellular functions to novel proteins and derivation of new biological pathways. See, e.g., Curr Protein Pept Sci. 2003 4(3):159 81.

In certain embodiments, the invention involves the direct analysis of analyte eluted from an extraction channel without any intervening sample processing step, e.g., concentration, desalting or the like. Thus, for example, a sample can be eluted from a capillary and directly analyzed by MS, SPR or the like. This is a distinct advantage over other sample preparation methods that require concentration, desalting or other processing steps before analysis. These extra steps can increase the time and complexity of the experiment, and can result in significant sample loss, which poses a major problem when working with low abundance analytes and small volumes.

One example of such an analytical technique is mass spectroscopy (MS). In application of mass spectrometry for the analysis of biomolecules, the molecules are transferred from the liquid or solid phases to gas phase and to vacuum phase. Since many biomolecules are both large and fragile (proteins being a prime example), two of the most effective methods for their transfer to the vacuum phase are matrix-assisted laser desorption ionization (MALDI) or electrospray ionization (ESI). Some aspects of the use of these methods, and sample preparation requirements, are known to those of ordinary skill in the art. In general ESI is more sensitive, while MALDI is faster. Significantly, some peptides ionize better in MALDI mode than ESI, and vice versa (Genome Technology, June 220, p 52). The extraction channel methods and devices of the instant invention are particularly suited to preparing samples for MS analysis, especially biomolecule samples such as proteins. An important advantage of the invention is that it allows for the preparation of an enriched sample that can be directly analyzed, without the need for intervening process steps, e.g., concentration or desalting.

ESI is performed by mixing the sample with volatile acid and organic solvent and infusing it through a conductive needle charged with high voltage. The charged droplets that are sprayed (or ejected) from the needle end are directed into the mass spectrometer, and are dried up by heat and vacuum as they fly in. After the drops dry, the remaining charged molecules are directed by electromagnetic lenses into the mass detector and mass analyzed. In one embodiment, the eluted sample is deposited directly from the capillary into an electrospray nozzle, e.g., the capillary functions as the sample loader. In another embodiment, the capillary itself functions as both the extraction device and the electrospray nozzle.

For MALDI, the analyte molecules (e.g., proteins) are deposited on metal targets and co-crystallized with an organic matrix. The samples are dried and inserted into the mass spectrometer, and typically analyzed via time-of-flight (TOF) detection. In one embodiment, the eluted sample is deposited directly from the capillary onto the metal target, e.g., the capillary itself functions as the sample loader. In one embodiment, the extracted analyte is deposited on a MALDI target, a MALDI ionization matrix is added, and the sample is ionized and analyzed, e.g., by TOF detection.

In other embodiments of the invention, channel extraction is used in conjunction with other forms of MS, e.g., other ionization modes. In general, an advantage of these methods is that they allow for the “just-in-time” purification of sample and direct introduction into the ionizing environment. It is important to note that the various ionization and detection modes introduce their own constraints on the nature of the desorption solution used, and it is important that the desorption solution be compatible with both. For example, the sample matrix in many applications must have low ionic strength, or reside within a particular pH range, etc. In ESI, salt in the sample can prevent detection by lowering the ionization or by clogging the nozzle. This problem is addressed by presenting the analyte in low salt and/or by the use of a volatile salt. In the case of MALDI, the analyte should be in a solvent compatible with spotting on the target and with the ionization matrix employed.

In some embodiments, the invention is used to prepare an analtye for use in an analytical method that involves the detection of a binding event on the surface of a solid substrate. These solid substrates are generally referred to herein as “binding detection chips,” examples of which include hybridization microarrays and various protein chips. As used herein, the term “protein chip” is defined as a small plate or surface upon which an array of separated, discrete protein samples (or “dots”) are to be deposited or have been deposited. In general, a chip bearing an array of discrete ligands (e.g., proteins) is designed to be contacted with a sample having one or more biomolecules which may or may not have the capability of binding to the surface of one or more of the dots, and the occurrence or absence of such binding on each dot is subsequently determined. A reference that describes the general types and functions of protein chips is Gavin MacBeath, Nature Genetics Supplement, 32:526 (2002). See also Ann. Rev. Biochem., 2003 72:783 812.

In general, these methods involve the detection binding between a chip-bound moiety “A” and its cognate binder “B”; i.e, detection of the reaction A+B=AB, where the formation of AB results, either directly or indirectly, in a detectable signal. Note that in this context the term “chip” can refer to any solid substrate upon which A can be immobilized and the binding of B detected, e.g., glass, metal, plastic, ceramic, membrane, etc. In many important applications of chip technology, A and/or B are biomolecules, e.g., DNA in DNA hybridization arrays or protein in protein chips. Also, in many cases the chip comprises an array multiple small, spatially-addressable spots of analyte, allowing for the efficient simultaneous performance of multiple binding experiments on a small scale.

In some embodiments, the technology is used to prepare a sample prior to detection by optical biosensor technology, e.g., the BIND biosensor from SRU Biosystems (Woburn, Mass.). Various modes of this type of label-free detection are described in the following references: B. Cunningham, P. Li, B. Lin, J. Pepper, “Colorimetric resonant reflection as a direct biochemical assay technique,” Sensors and Actuators B, Volume 81, p. 316 328, Jan. 5, 2002; B. Cunningham, B. Lin, J. Qiu, P. Li, J. Pepper, B. Hugh, “A Plastic Colorimetric Resonant Optical Biosensor for Multiparallel Detection of Label-Free Biochemical Interactions,” Sensors & Actuators B, volume 85, number 3, pp 219 226, (November 2002); B. Lin, J. Qiu, J. Gerstemnaier, P. Li, H. Pien, J. Pepper, B. Cunningham, “A Label-Free Optical Technique for Detecting Small Molecule Interactions,” Biosensors and Bioelectronics, Vol. 17, No. 9, p. 827 834, September 2002; Cunningham, J. Qiu, P. Li, B. Lin, “Enhancing the Surface Sensitivity of Colorimetric Resonant Optical Biosensors,” Sensors and Actuators B, Vol. 87, No. 2, p. 365 370, December 2002, “Improved Proteomics Technologies,” Genetic Engineering News, Volume 22, Number 6, pp 74 75, Mar. 15, 2002; and “A New Method for Label-Free Imaging of Biomolecular Interactions,” P. Li, B. Lin, J. Gerstemnaier, and B. T. Cunningham, Accepted July, 2003, Sensors and Actuators B.

In some modes of optical biosensor technology, a colorimetric resonant diffractive grating surface is used as a surface binding platform. A guided mode resonant phenomenon is used to produce an optical structure that, when illuminated with white light, is designed to reflect only a single wavelength. When molecules are attached to the surface, the reflected wavelength (color) is shifted due to the change of the optical path of light that is coupled into the grating. By linking receptor molecules to the grating surface, complementary binding molecules can be detected without the use of any kind of fluorescent probe or particle label. High throughput screening of pharmaceutical compound libraries with protein targets, and microarray screening of protein-protein interactions for proteomics are examples of applications that can be amenable to this approach.

In some embodiments, the invention is used to prepare an analyte for detection by acoustic detection technology such as that being commercialized by Akubio Ltd. (Cambridge, UK). Various modes of this type of label-free detection are described in the following references: M. A. Cooper, “Label-free screening of molecular interactions using acoustic detection,” Drug Discovery Today 2002, 6 (12) Suppl.; M. A. Cooper “Acoustic detection of pathogens using rupture event scanning (REVS),” Directions in Science, 2002, 1, 1 2; and M. A. Cooper, F. N. Dultsev, A. Minson, C. Abell, P. Ostanin and D. Klenerman, “Direct and sensitive detection of a human virus by rupture event scanning,” Nature Biotech., 2001, 19, 833 837.

In some embodiments the invention is used to prepare an analyte for detection by atomic force microscopy, scanning force microscopy and/or nanoarray technology such as that being commercialized by BioForce Nanosciences Inc. (Ames, Iowa).

In some embodiments the invention is used to prepare an analyte for detection by a technology involving activity-based protein profiling such as that being commercialized by ActivX, Inc. (La Jolla, Calif.). Various modes of this methodology are described in the following references: Kidd et al. (2001) Biochemistry 40:4005 4015; Adam et al. (2000) Chemistry and Biology 57:1 16; Liu et at. (1999) PNAS 96(26):146940 14699; Cravat and Sorensen (2000) Curr. Opin. Chem. Biol. 4:663 668; Patricelli et al. (2001) Proteomics 1 1067 71.

In some embodiments the invention is used to prepare an analyte for analysis by a technology involving a kinetic exclusion assay, such as that being commercialized by Sapidyne Instruments Inc. (Boise, Id.). See, e.g., Glass, T. (1995) Biomedical Products 20(9): 122 23; and Ohumura et al. (2001) Analytical Chemistry 73 (14):3 3 92 99.

The technology used to take up and dispense liquids in the extraction capillaries can be similar to that used for capillary electrophoresis instruments where very small amounts of sample are taken up and dispensed into the capillary. This can also be done in 96 and 384 capillary arrays as are the capillary units used for DNA sequencing. Related techniques are described in Andre Marziali, et al., Annu. Rev. Biomet. Eng., 3:195 (2001). In some cases, the end of the capillary used for solid phase extraction can be the spotter itself. Related techniques are described in MICROARRAY BIOCHIP TECHNOLOGY, Chapter 2—Microfluidic Technologies and Instrumentation for Printing DNA Microarrays, Mark Schena (Editor), Telechem International, Eaton Publishing, ISBN 1-881299-3 7-6 (2000).

In some embodiments, the systems and methods of the invention are useful for preparing protein samples for crystallization, particularly for use in X-ray crystallography-based protein structure determination. The invention is particularly suited for preparation of samples for use in connection with high throughput protein crystallization methods. These methods typically require small volumes of relatively concentrated and pure protein, e.g., on the order of 1 μL, per crystallization condition tested. Instrumentation and reagents for performing high throughput crystallization are available, for example, from Hampton Research Corp. (Aliso Viejo, Calif.), RoboDesign International Inc. (Carlsbad, Calif.), Genomic Solutions, Inc. (Ann Arbor, Mich.) and Corning Life Sciences (Kennebunk, Me.). Typically, protein crystallization involves mixing the protein with a mother liquor to form a protein drop, and then monitoring the drop to see if suitable crystals form, e.g., the sitting drop or hanging drop methods. Since the determination of appropriate crystallization conditions is still largely empirical, normally a protein is tested for crystallization under a large number of different conditions, e.g., a number of different candidate mother liquors are used. The protein can be purified by channel extraction prior to mixture with mother liquor. The sample can be collected in an intermediate holding vessel, from which it is then transferred to a well and mixed with mother liquor. Alternatively, the protein drop can be dispenses directly from the channel to a well.

The invention is particularly suited for use in a high-throughput mode, where drops of protein sample are introduced into a number of wells, e.g., the wells of a multi-well plate (e.g., 94, 384 wells, etc.) such as a CrystalEX 384 plate from Corning (Corning Life Sciences, Kennebunk Me.). The protein drops and/or mother liquors can be dispensed into microwells using a high precision liquid dispensing system such as the Cartesian. Dispensing System Honeybee (Genomic Solutions, Inc., Ann Arbor, Mich.). In high throughput modes it is desirable to automate the process of crystals trial analysis, using for example a high throughput crystal imager such as the RoboMicroscope III (RoboDesign International Inc., Carlsbad, Calif.).

Other analytical techniques particularly suited for use in conjunction with certain embodiments of the invention include surface immobilized assays, immunological assays, various ligand displacement/competition assays, direct genetic tests, biophysical methods, direct force measurements, NMR, electron microscopy (including cryo-EM), microcalorimetry, mass spectroscopy, IR and other methods such as those discussed in the context of binding detection chips, but which can also be used in non-chips contexts.

In accordance with the invention there may be employed conventional chemistry, biological and analytical techniques within the skill of the art. Such techniques are explained fully in the literature. See, e.g., Antibody Purification Handbook, Amersham Biosciences, Edition AB, 18-1037-46 (2002); Protein Purification Handbook, Amersham Biosciences, Edition AC, 18-1132-29 (2001); Affinity Chromatography Principles and Methods, Amersham Pharmacia Biotech, Edition AC, 18-1022-29 (2001); The Recombinant Protein Handbook, Amersham Pharmacia Biotech, Edition AB, 18-1142-75 (2002); and Protein Purification: Principles, High Resolution Methods, and Applications, Jan-Christen Janson (Editor), Lars G. Ryden (Editor), Wiley, John & Sons, Incorporated (1989); Chromatography, 5.sup.th edition, PART A: FUNDAMENTALS AND TECHNIQUES, editor: E. Heftmann, Elsevier Science Publishing Company, New York, pp A25 (1992); ADVANCED CHROMATOGRAPHIC AND ELECTROMIGRATION METHODS IN BIOSCIENCES, editor: Z. Deyl, Elsevier Science BV, Amsterdam, The Netherlands, pp 528 (1998); CHROMATOGRAPHY TODAY, Colin F. Poole and Salwa K. Poole, and Elsevier Science Publishing Company, New York, pp 394 (1991); F. Dorwald ORGANIC SYNTHESIS ON SOLID PHASE, Wiley VCH Verlag Gmbh, Weinheim 2002.

### Devices and Kits

The invention provides solid phase extraction devices as described above and kits comprising such devices and instructions for using the devices in accordance with the methods of the invention described herein.

In certain embodiments, the SPE device is selected from the group consisting of micro elution plates, chromatographic columns, thin layer plates, sample cleanup devices, injection cartridges, microtiter plates and chromatographic preparatory devices.

In particular embodiments, SPE device is a micro-elution plate or a chromatographic column.

In one embodiment, the SPE device is a multi-well micro-elution plate, e.g., a 96-well micro-elution plate. In another embodiment, the SPE device is a chromatographic column, e.g., a microbore column, capillary column, or nanocolumn.

The SPE devices are packed with an alumina sorbent, e.g., an HPLC grade alumina sorbent. In certain embodiments, the alumina sorbent is selected from the group consisting of alumina A, alumina N and alumina B. In a particular embodiment, the SPE device is a micro-elution plate into which is packed alumina B.

In certain embodiments, the size of the alumina sorbent particles ranges from about 18 to about 32 μm.

### EXAMPLES

The invention is further illustrated by the following examples which should in no way be construed as being further limiting.

### Materials and Methods

A test sample was prepared by mixing four synthetic phosphopeptides (T18_{—}1P, T19_{—}1P, T43_{—}1P and T43_{—}2P, which are modified versions of tryptic enolase peptides) with unmodified yeast enolase tryptic peptides in 1:10 molar ratio. The test sample was reconstituted in low pH (<1), high organic solvent (e.g., 80% acetonitrile) for loading onto the SPE device. The SPE was washed with the same low pH, high organic solvent. Affinity bonded analytes were eluted with highly basic pH eluent (>10).

### Example 1

In this example, solid phase extraction using Alumina B sorbent in accordance with the invention was compared with the IMAC NTA-Fe(III) method. A 96-well SPE micro elution plate device, packed with 2.5 mg Alumina B sorbent (particle size was 18-32 μm) per well, was prepared. (Alumina HPLC/UPLC particles can also be packed into columns and trapping columns suitable for on-line phosphopeptide isolation followed by nanoLC-MS analysis.) The sample was loaded onto the micro elution plate using a 0.2-0.5% trifluoroacetic acid (pH<1) polar organic solvent (80% acetonitrile) mixture. The affinity-adsorbed phosphopeptides were eluted using a 0.3N ammonium hydroxide solution.

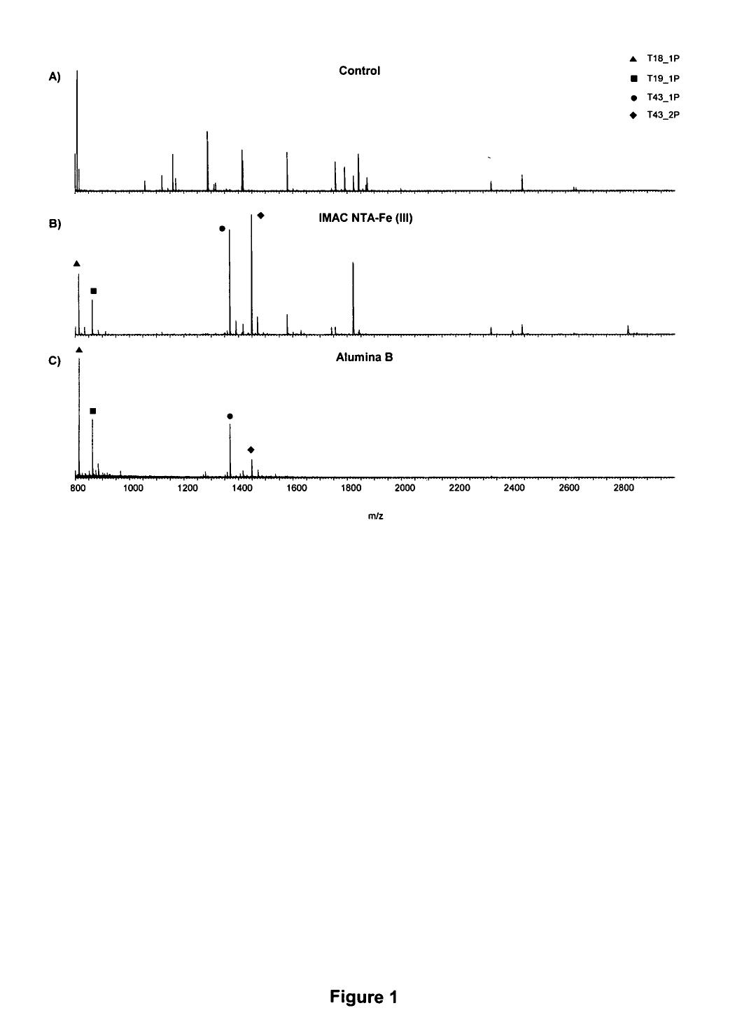

MALDI-TOF mass spectroscopy was carried out A) the test sample as a control; B) the eluent obtained from processing the test sample using the IMAC method; and C) the eluent obtained from the solid phase extraction using Alumina B sorbent in accordance with the invention and the spectroscopic results are shown in FIG. 1. FIG. 1A shows no detection of the phosphopeptides. A comparison of FIGS. 1B and 1C reveals that the best selectivity for phosphopeptides was achieved with solid phase extraction using Alumina B sorbent in accordance with the invention (FIG. 1C).

### Example 2

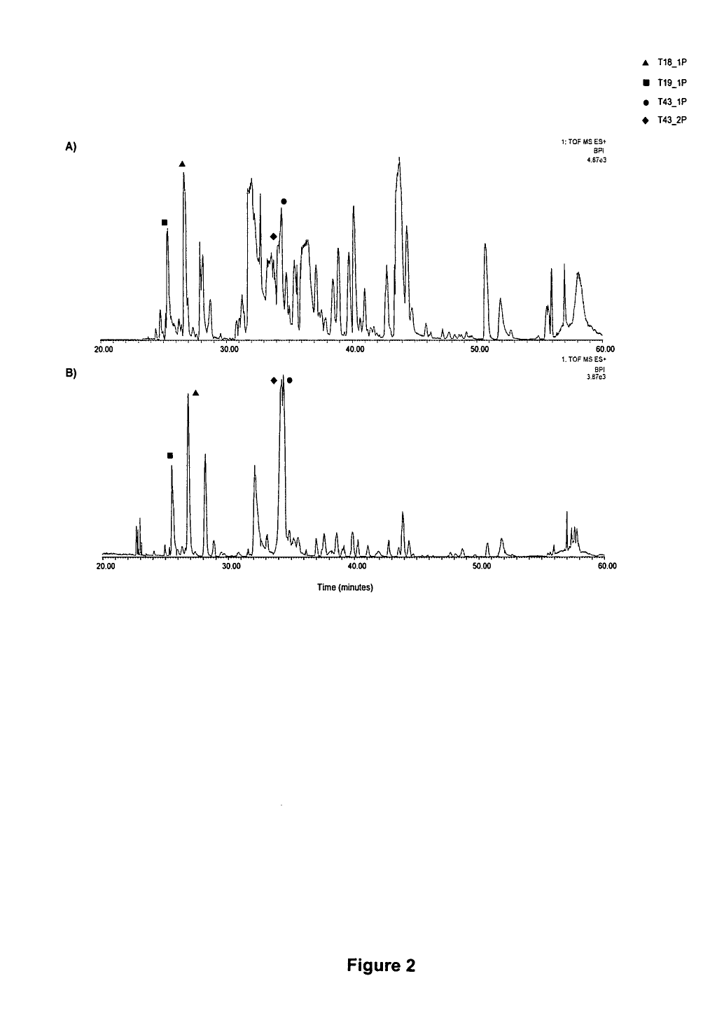

In this example, solid phase extraction using Alumina B sorbent in accordance with the invention was compared with TiO₂ affinity chromatography. The test sample was prepared as described above. Liquid chromatography/mass spectrum (LC/MS) analysis was carried out on A) the extract obtained from subjecting the test sample to TiO₂ affinity chromatography B) the extract obtained from subjecting the test sample to solid phase extraction using Alumina B sorbent in accordance with the invention, and the results of the analysis are shown in FIG. 2. As can be seen from a comparison of FIGS. 2A and 2B, the method of the invention (FIG. 2B) provides a significantly cleaner extract containing the phospopeptides as the predominant species isolated. In contrast, TiO₂ affinity chromatography (FIG. 2A) shows significant coextraction of non-phosphorylated peptides.

### Example 3

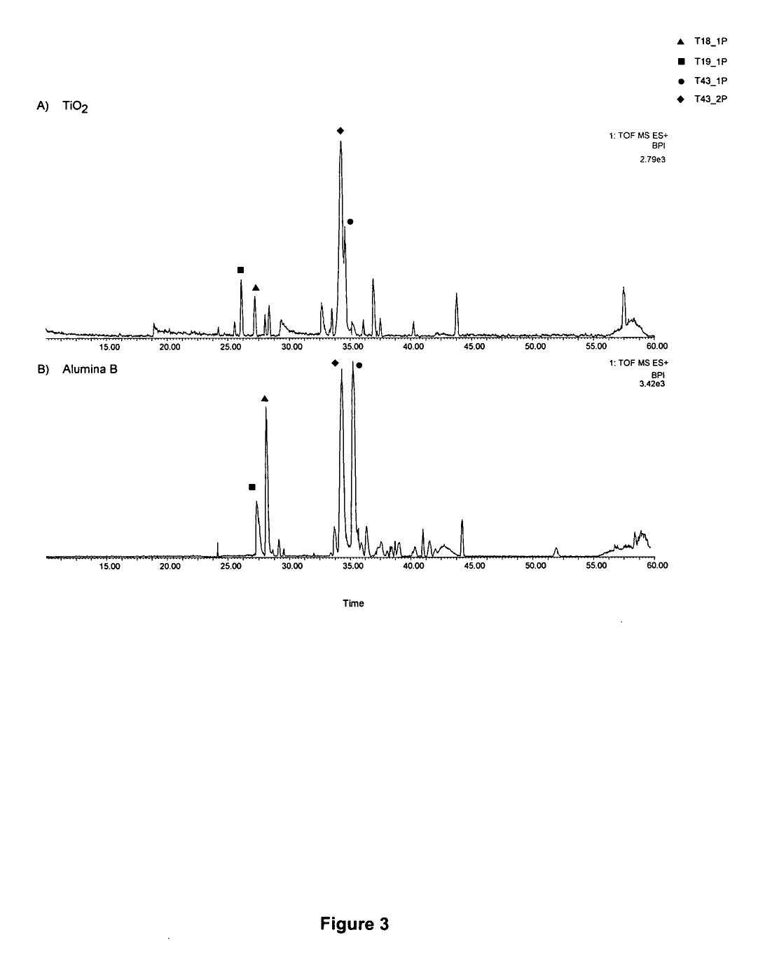

This example was carried out as described in Example 2, except that a displacement agent (Enhancer™, available from Waters Corporation, Milford, Mass.) was used in the loading step of both methods to improve selectivity: 40 mg of the displacement agent was used in the loading step of the TiO₂ affinity chromatography method; and 8 mg of the displacement agent was used in the loading step of the Alumina B method of the invention. LC/MS analysis was carried out on A) the extract obtained from subjecting the test sample to TiO₂ affinity chromatography B) the extract obtained from subjecting the test sample to solid phase extraction using Alumina B sorbent in accordance with the invention, and the results of the analysis are shown in FIG. 3.

As can be seen from FIGS. 3A and 3B, the method of the invention (FIG. 3B) provides similar or better selectivity for phosphopeptides as compared to TiO₂ affinity chromatography (FIG. 3A) using significantly less of the displacement reagent. Using a lower amount of the displacement agent reduces loss of phophopeptides during solid phase extraction.

### Incorporation by Reference

The contents of all references (including literature references, issued patents, published patent applications, and co-pending patent applications) cited throughout this application are hereby expressly incorporated herein in their entireties by reference.

### Equivalents

Those skilled in the art will recognize, or be able to ascertain using no more than routine experimentation, many equivalents of the specific embodiments of the invention described herein. Such equivalents are intended to be encompassed by the following claims.

1. A method for selectively isolating a functionalized macromolecule from a sample, the method comprising the steps of:
a) loading a sample containing a functionalized macromolecule onto a solid phase extraction (SPE) device comprising a packed alumina sorbent under conditions such that the functionalized macromolecule is selectively adsorbed onto the alumina sorbent; and
b) eluting the adsorbed functionalized macromolecule from the alumina sorbent, thereby selectively isolating the functionalized macromolecule from the sample.

2. A method for selectively isolating a plurality of functionalized macromolecules from a sample, the method comprising the steps of:
a) loading a sample containing a plurality of functionalized macromolecules onto a first solid phase extraction (SPE) device comprising a packed alumina sorbent under conditions such the plurality of functionalized macromolecule are selectively adsorbed onto the alumina sorbent; and
b) eluting the adsorbed functionalized macromolecules from the alumina sorbent;
c) collect at least one fraction;
d) loading the at least one fraction onto a second solid phase extraction (SPE) device comprising a packed alumina sorbent under conditions such that at least two functionalized macromolecule are selectively adsorbed onto the alumina sorbent; and
c) eluting the at least two adsorbed functionalized macromolecules from the alumina sorbent of the second solid phase extraction (SPE) device, thereby selectively isolating a plurality of functionalized macromolecules from the sample.

3. A method for purifying a functionalized macromolecule contained in a sample, the method comprising:
a) loading a sample containing a functionalized macromolecule onto a solid phase extraction (SPE) device comprising a packed alumina sorbent under conditions such that the functionalized macromolecule is selectively adsorbed onto the alumina sorbent; and
b) eluting the adsorbed functionalized macromolecule from the alumina sorbent, thereby selectively isolating the functionalized macromolecule from the sample, thereby purifying a functionalized macromolecule.

4. A method for detecting a functionalized macromolecule in a sample, the method comprising the steps of:
a) loading a sample containing a functionalized macromolecule onto a solid phase extraction (SPE) device comprising a packed alumina sorbent under conditions such that the functionalized macromolecule is selectively adsorbed onto the alumina sorbent; and
b) eluting the adsorbed functionalized macromolecule from the alumina sorbent, thereby selectively isolating the functionalized macromolecule from the sample, thereby purifying a functionalized macromolecule.; and
c) detecting the functionalized macromolecule.

5. The method of claim 1, wherein the functionalized macromolecule is selected from the group consisting of a peptide, a polypeptide, a phosphopeptide, a glycopeptide, a protein, a phosphoprotein, a nucleic acid, an oligonucletoide, a polynucelotide, a phospholipid, a synthetic or natural polymer and mixtures thereof.

6. The method of claim 1, wherein the functionalized macromolecule is selected from the group consisting of a peptide, a polypeptide, a protein, a phosphopeptide, an oligonucleotide and a phospholipid.

7. The method of claim 6, wherein the functionalized macromolecule comprises a highly acidic side chain.

8. The method of claim 6, wherein the functionalized macromolecule is a peptide, polypeptide or protein comprising a phosphate group, a sulfonate group, or a sialylate group.

9. The method of claim 6, wherein the peptide is a phosphopeptide.

10. The method of claim 9, wherein the phosphopeptide is selected from the group consisting of T18_P, T19_{—}1P, T43_{—}1P and T43_{—}2P.

11. The method of claim 8, wherein the functionalized macromolecule is selectively isolated over an acidic peptide, a neutral peptide, or a basic peptide.

12. The method of claim 9, wherein functionalized macromolecule is selectively isolated over an acidic peptide.

13. The method of claim 8, wherein the functionalized macromolecule is a phosphopeptide, sialylated glycopeptide, sulfonated peptide or sulfonated glycopeptide.

14. The method of claim 1, wherein the functionalized macromolecule is a phosphopeptide, an oligonucleotide, phospholipid or a sialylated glycopeptide.

15. (canceled)

16. The method of claim, wherein the SPE device is selected from the group consisting of micro elution plates, chromatographic columns, thin layer plates, sample cleanup devices, injection cartridges, microtiter plates and chromatographic preparatory devices.

17-19. (canceled)

20. The method of claim 1, wherein the alumina sorbent is selected from the group consisting of alumina A, alumina N and alumina B.

21. The method of claim 20, wherein: the alumina A has a pH of about 4.5; the alumina N has a pH of about 7; or the alumina B has a pH of about 10.

22-28. (canceled)

29. The method of claim 20, wherein the size of the alumina sorbent particles ranges from about 18 to about 32 μm.

30-46. (canceled)

47. A method for selectively isolating a phosphopeptide, oligonucleotide or phospholipid from a sample comprising a biological mixture, the method comprising the steps of:
a) dissolving the sample in a solution comprising an acid and an organic solvent;
b) loading the dissolved sample onto a solid phase elution plate or column comprising a packed alumina sorbent under conditions such that the phosphopeptide, oligonucleotide or phospholipid is selectively adsorbed onto the alumina sorbent;
c) eluting the phosphopeptide, oligonucleotide or phospholipid from the alumina using a basic mobile phase; and
d) collecting the isolated phosphopeptide, oligonucleotide or phospholipid, thereby selectively isolating a phosphopeptide, oligonucleotide or phospholipid.

48-55. (canceled)

56. A kit comprising a solid phase extraction (SPE) device comprising a solid phase extraction (SPE) device comprising a packed alumina sorbent and instructions for use in accordance with a method according to claim 1.

57-64. (canceled)
